(19) United States
(12) Patent Application Publication
(10) Pub. No.: US 2016/0107718 A1
(43) Pub. Date: Apr. 21, 2016

(54) BRAKING MECHANISM FOR A FOOT-DECK-BASED VEHICLE

(71) Applicant: YVOLVE SPORTS LTD., Dublin (IE)

(72) Inventor: Thomas O Connell, Castleblayney (IE)

(21) Appl. No.: 14/866,666

(22) Filed: Sep. 25, 2015

(30) Foreign Application Priority Data
Oct. 21, 2014 (CN) 201420610924.9

(51) Int. Cl. B62L 3/04; B62L 1/04; B60T 7/06; B62K 3/00; B60T 1/04; F16D 49/00

(52) U.S. Cl. CPC B62L 3/04; B60T 1/04; F16D 49/00; B60T 7/06; B62K 3/002; B62L 1/04

(57) ABSTRACT

A foot-deck-based vehicle comprises a foot-deck with an aperture therethrough between a foot support surface and an underside of the foot-deck, and a plurality of wheels. At least one of the plurality of wheels is a brakable wheel positioned entirely beneath the foot-deck. A foot-actuatable member extends through the aperture and, in use, up from the support surface. A braking member is movable between a non-braking position away from the at least one brakable wheel and a braking position in which the braking member engages the at least one brakable wheel to generate a resisting force to reduce the speed of the foot-deck-based vehicle. The foot-actuatable member is operatively connected to the braking member and is depressible towards the foot support surface to move the braking member to the braking position. A biasing member is positioned to urge the braking member towards the non-braking position.

### CROSS-REFERENCE TO RELATED APPLICATIONS

This application claims the benefit of Chinese Utility Model No. 201420610924.9, filed on Oct. 21, 2014, the contents of which are incorporated herein by reference in their entirety.

### FIELD

The specification relates generally to foot-deck-based vehicles, and specifically to a foot-deck-based vehicle having a braking mechanism.

### BACKGROUND OF THE DISCLOSURE

In typical user-propelled, foot-deck-based vehicles, such as scooters, braking is performed by depressing a flap or extension of the footboard into contact with a rear wheel of the vehicle. This flap or extension is usually extended above and over the rear wheel. In use, in order to brake or reduce the speed of the vehicle, a user will have to lift one of their feet off the footboard and extend it towards the rear of the footboard to reach the flap. This can be cumbersome and may require at least some heightened sense of balance. If a user does not have the requisite balance, braking the vehicle may be dangerous.

It may be helpful to develop a foot-deck-based vehicle that may address this problem.

### SUMMARY OF THE DISCLOSURE

According to a first set of embodiments, there is provided a brake module for a scooter having a plate body having an opening, at least one front wheel and at least one rear wheel. The brake module includes, but is not necessarily limited to: a driving component that extends through the opening in the plate body; at least one connecting rod coupled to the driving component at one end of the at least one connecting rod; a push surface coupled to another end of the at least one connecting rod, the push surface configured to contact the at least one rear wheel, and to generate a resisting force against rotation of the at least one rear wheel when the push surface is moved to contact the at least one rear wheel; and an elastic part positioned to apply a restoring force against the push surface when the push surface contacts the at least one rear wheel to move the push surface away from the at least one rear wheel. The driving component is configured to drive the at least one connecting rod towards the at least one rear wheel in response to a downward force applied to the driving component. The push surface is moved by the at least one connecting rod into contact with the at least one rear wheel.

There is also provided a foot-deck-based vehicle that includes, but is not necessarily limited to, a foot-deck, a plurality of wheels, a foot-actuatable member, a braking member and a biasing member. The foot-deck includes, in use, a foot support surface and an underside. In use, the foot support surface is positioned to support the feet of a user and the foot-deck has an aperture therethrough between the foot support surface and the underside. The plurality of wheel includes at least one front wheel positioned proximate a front end of the foot-deck and at least one rear wheel positioned proximate a rear end of the foot-deck. The plurality of wheels is positioned in association with the foot-deck and at least one of the plurality of wheels is a brakable wheel which is positioned entirely beneath the foot-deck. The foot-actuatable member extends through the aperture and, in use, up from the foot support surface. The braking member is movable between a non-braking position away from the at least one brakable wheel and a braking position in which the braking member engages the at least one brakable wheel to generate a resisting force to reduce speed of the foot-deck-based vehicle. The foot-actuatable member is operatively connected to the braking member and is depressible towards the foot support surface to move the braking member to the braking position. The biasing member is positioned to urge the braking member towards the non-braking position.

In some embodiments, the at least one brakable wheel is at least one of the at least one rear wheel. In some embodiments, the at least one brakable wheel is the at least one rear wheel.

There is also provided a brake mechanism for a foot-deck-based vehicle. The foot-deck-based vehicle has a foot-deck having, in use, a foot support surface and an underside. In use, the foot support surface is positioned to support the feet of a user. The foot-deck has an aperture therethrough between the foot support surface and the underside. The foot-deck-based vehicle further includes a plurality of wheels including at least one front wheel positioned proximate a front end of the foot-deck and at least one rear wheel positioned proximate a rear end of the foot-deck. The plurality of wheels are positioned in association with the foot-deck and at least one of the plurality of wheels is a brakable wheel which is positioned entirely beneath the foot-deck. The brake mechanism includes, but is not necessarily limited to, a foot-actuatable member, a braking member and a biasing member. The foot-actuatable member extends through the aperture and, in use, up from the foot support surface. The braking member is movable between a non-braking position away from the at least one brakable wheel and a braking position in which the braking member engages the at least one brakable wheel to generate a resisting force to reduce the speed of the foot-deck-based vehicle. The foot-actuatable member is operatively connected to the braking member and is depressible towards the foot support surface to move the braking member to the braking position. The biasing member is positioned to urge the braking member towards the non-braking position.

There is also provided another brake mechanism for a foot-deck-based vehicle. The foot-deck-based vehicle has a foot-deck having, in use, a foot support surface and an underside. In use, the foot support surface is positioned to support the feet of a user. The foot-deck has an aperture therethrough between the foot support surface and the underside. The aperture is enclosed entirely by the foot-deck. The foot-deck-based vehicle further includes a plurality of wheels including at least one front wheel positioned proximate a front end of the foot-deck and at least one rear wheel positioned proximate a rear end of the foot-deck. The plurality of wheels are positioned in association with the foot-deck and at least one of the plurality of wheels is a brakable wheel. The brake mechanism includes, but is not necessarily limited to, a foot-actuatable member, a braking member and a biasing member. The foot-actuatable member extends through the aperture and, in use, up from the foot support surface. The braking member is movable between a non-braking position away from the at least one brakable wheel and a braking position in which the braking member engages the at least one brakable wheel to generate a resisting force to reduce the speed of the foot-deck-based vehicle. The foot-actuatable member is operatively connected to the braking member and is depressible towards the foot support surface to move the braking member to the braking position. The biasing member is positioned to urge the braking member towards the non-braking position.

### BRIEF DESCRIPTIONS OF THE DRAWINGS

For a better understanding of the various embodiments described herein and to show more clearly how they may be carried into effect, reference will now be made, by way of example only, to the accompanying drawings in which:

FIG. 1 is an exploded view of a scooter including a braking module, according to one set of non-limiting embodiments;

FIG. 2 is an assembled view of the scooter depicted in FIG. 1;

FIG. 3 is a side elevation view of the scooter depicted in FIG. 1;

FIG. 4 is an enlarged view of the rear wheels and plate body of the scooter depicted in FIG. 1;

FIG. 5 is a partially enlarged cross-sectional view of a braking module of the scooter depicted in FIG. 1, according to one set of non-limiting embodiments;

FIG. 6 is a schematic of an enlarged view of a braking module of the scooter depicted in FIG. 1, according to one set of non-limiting embodiments;

FIG. 7 is a schematic of an enlarged view of the braking module depicted in FIG. 6 in which the push surface is moved to press against a rear wheel;

FIG. 8 is a schematic of a user and the scooter depicted in FIG. 1;

FIG. 9 is a partially enlarged sectional view of a braking module of the scooter depicted in FIG. 1, according to a second set of embodiments;

FIG. 10 is a front perspective view of a foot-deck-based vehicle, according to a non-limiting embodiment;

FIG. 11 is a side elevation view of the foot-deck-based vehicle depicted in FIG. 10;

FIG. 12 is an enlarged side elevation view of a brake mechanism for a foot-deck-based vehicle, according to a non-limiting embodiment;

FIG. 13 is an enlarged section view of the brake mechanism depicted in FIG. 12 in a non-braking position;

FIG. 14A is an enlarged section view of the brake mechanism depicted in FIG. 12 in a braking position;

FIG. 14B is an enlarged view of the brake mechanism depicted in FIG. 14A;

FIG. 15 is an enlarged side elevation view of the brake mechanism depicted in FIG. 12 in a non-braking position;

FIG. 16 is an enlarged side elevation view of the brake mechanism depicted in FIG. 12 in a braking position;

FIG. 17 is a cross-sectional view of the foot-deck-based vehicle depicted in FIG. 10 showing a truck, according to a non-limiting embodiment;

FIG. 18 is an enlarged view of the rear wheels, foot-deck and truck of the foot-deck-based vehicle depicted in FIG. 10;

FIG. 19 is an enlarged rear elevation view of the foot-deck-based vehicle depicted in FIG. 10;

FIG. 20 is an enlarged bottom perspective view of the foot-deck-based vehicle depicted in FIG. 10;

FIG. 21A is a schematic of an enlarged view an aperture in a foot-deck with a foot-actuatable member, according to a non-limiting embodiment;

FIG. 21B is a schematic of a sectional view of the aperture in the foot-deck with the foot-actuatable member shown in FIG. 21A;

FIG. 22 is a schematic of an enlarged view an aperture in a foot-deck with a with a foot-actuatable member, according to another non-limiting embodiment;

FIG. 23 is a schematic of an enlarged view of an aperture in a foot-deck, according to another non-limiting embodiment;

FIG. 24A is an enlarged view of a foot-deck with a foot-actuatable member, according to a non-limiting embodiment; and

FIG. 24B is an enlarged view of the foot-deck with the foot-actuatable member depicted in FIG. 24A.

### DETAILED DESCRIPTION

To solve the above-mentioned technical problem, according to one set of embodiments, there is described a shifting lock of a scooter. In the actual implementation, the driving component is operated to drive the first connecting rod and drag the push surface of the second connecting rod to press against the rear wheel. In addition, as the push surface can only shift in the direction of the second connecting rod, the push surface is driven towards the rear wheel and slows down the rear wheel, thereby completing the action of braking, and the elastic part can allow the second connecting rod, the first connecting rod, and the driving component to restore to their respective original states in sequence.

To achieve the above-mentioned purpose, according to one set of embodiments there is described a shifting lock of a scooter. The scooter is provided with a rod body. The top of the rod body is provided with a grip part, and the bottom of the rod body is pivoted to a front wheel. The rod body extends backwards and is provided with a support bar. The upper part of the support bar is provided with a plate body, and the latter end of the support bar is pivoted to at least one rear wheel by using a fixing seat. The rear wheel is provided with a brake module. The brake module comprises a driving component and at least one first connecting rod. The driving component is connected to one end of the first connecting rod, and the other end of the first connecting rod is pivoted to the fixing seat by using a pivot shaft. The first connecting rod extends backwards and is provided with a push surface.

To achieve the above-mentioned purpose, according to one set of embodiments there is described another shifting lock of a scooter. The scooter is provided with a rod body. The top of the rod body is provided with a grip part, and the bottom of the rod body is pivoted to a front wheel. The rod body extends backwards and is provided with a support bar. The upper part of the support bar is provided with a plate body, and the latter end of the support bar is pivoted to at least one rear wheel by using a fixing seat. The rear wheel is provided with a brake module. The brake module comprises a driving component, a first connecting rod, a second connecting rod, and an elastic part. The lower part of the driving component extends and is provided with the first connecting rod. The first connecting rod is pivoted to one end of the second connecting rod relative to the other end of the driving component. The second connecting rod is pivoted to the fixing seat relative to the other end of the first connecting rod. The second connecting rod extends towards the rear wheel and is provided with a push surface. The driving component shifts downwards, allowing the push surface to come into contact with the rear wheel. The elastic part provides an upward restoring force for the driving component.

According to the above-mentioned main structural characteristics, the elastic part can be sleeved in the pivot shaft, or the elastic part can be sleeved outside the driving component.

According to the above-mentioned main structural characteristics, the driving component is a pedal part.

According to the above-mentioned main structural characteristics, the surface of the pedal part is provided with a plurality of raised lines.

According to the above-mentioned main structural characteristics, the pedal part is embedded in a floating manner in the rear end of the plate board.

According to the above-mentioned main structural characteristics, when operated, the pedal part, vertically shifting up and down in the floating mode, drives the first connecting rod and drags the push surface to press against the rear wheel.

According to the above-mentioned main structural characteristics, the plate body is provided with an opening relative to the pedal part for exposing the pedal part outside the plate body, and a gap is provided between the pedal part and the opening.

According to the above-mentioned main structural characteristics, the push surface is a brake block.

According to the above-mentioned main structural characteristics, the fixing seat is pivoted to one rear wheel.

According to the above-mentioned main structural characteristics, the fixing seat is pivoted to two rear wheels. The push surface is formed as an extension extending towards one of the rear wheels so that the push surface comes into contact with only one of the rear wheels.

According to the above-mentioned main structural characteristics, the fixing seat is pivoted to two rear wheels. The push surface formed as an extension extending towards both rear wheels so that the push surface comes into contact with both rear wheels.

According to the above-mentioned main structural characteristics, the support bar is bonded with the plate body by using at least one fixing module.

According to the above-mentioned main structural characteristics, the fixing module comprises a fixing plate and a plurality of screw-locking components.

According to the above-mentioned main structural characteristics, the fixing seat is bonded with one side of the support bar by using a fixing module.

According to the above-mentioned main structural characteristics, the brake module is located relative to the front of the rear wheel.

According to the above-mentioned main structural characteristics, the brake module is located relative to the rear of the rear wheel.

Specifically, described is a shifting lock of a scooter. In actual use, the driving component is operated to drive the first connecting rod and drag the push surface of the second connecting rod to press against the rear wheel. In addition, as the push surface can only shift in the direction of the second connecting rod, the push surface is driven towards and slows down the rear wheel, thereby completing the action of braking, and the elastic part can allow the second connecting rod, the first connecting rod, and the driving component to restore to their respective original states in sequence.

It is understood that for the purpose of this disclosure, language of “at least one of X, Y, and Z” and “one or more of X, Y and Z” can be construed as X only, Y only, Z only, or any combination of two or more items X, Y, and Z (e.g., XYZ, XYY, YZ, ZZ).

It is also understood that the terms “couple”, “coupled”, “connect”, “connected” are not limited to direct mating between the described components, but also contemplate the use of intermediate components to achieve the connection or coupling.

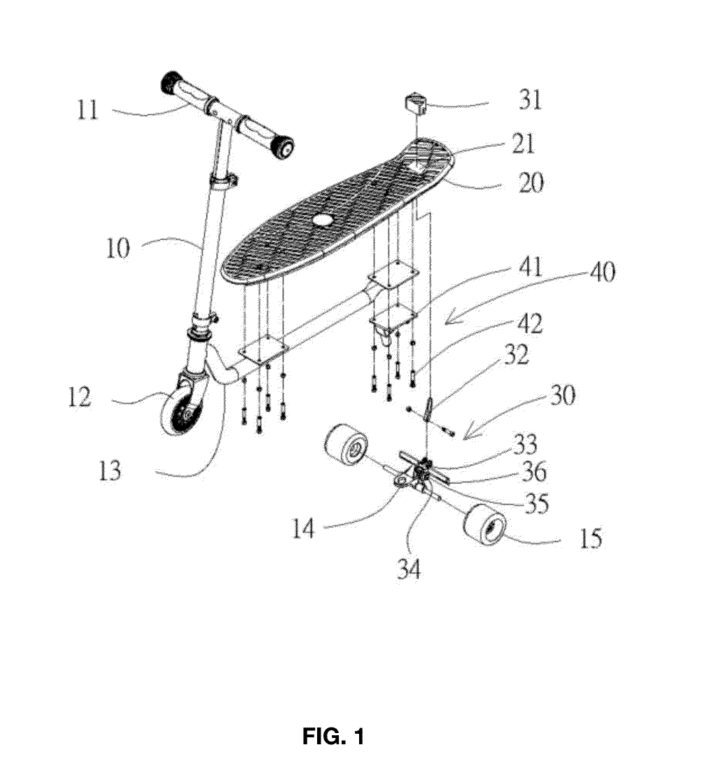

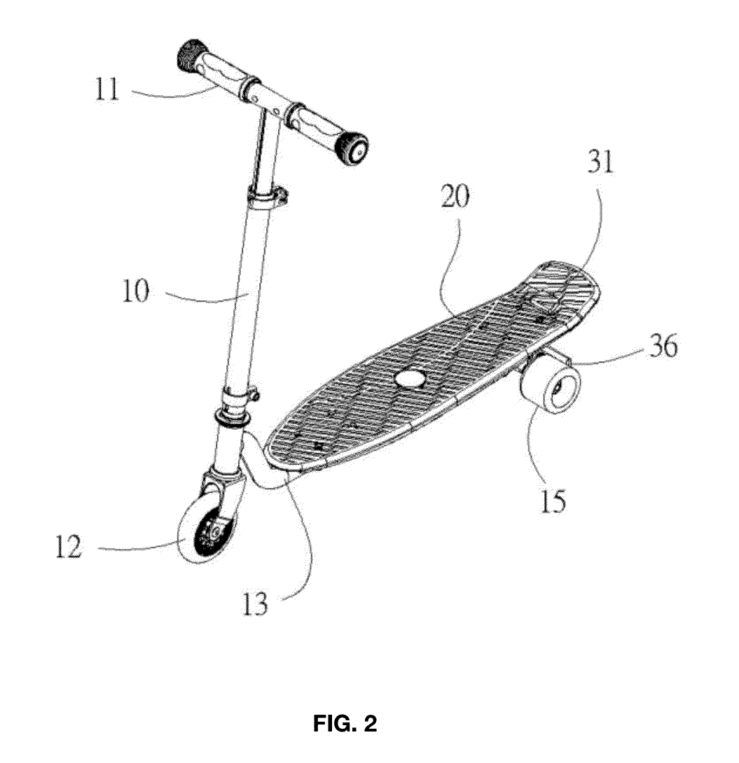

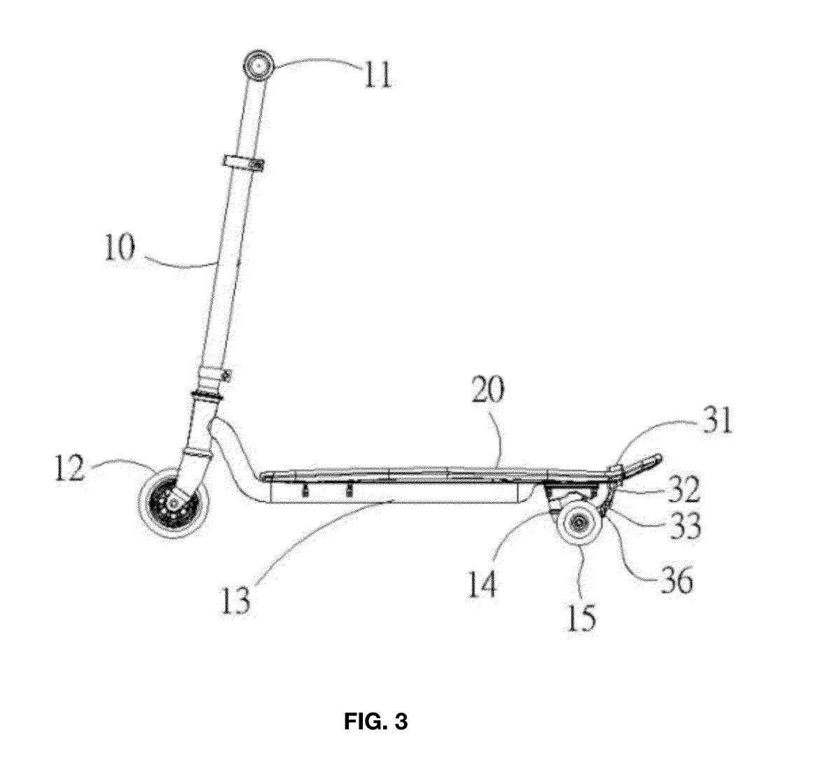

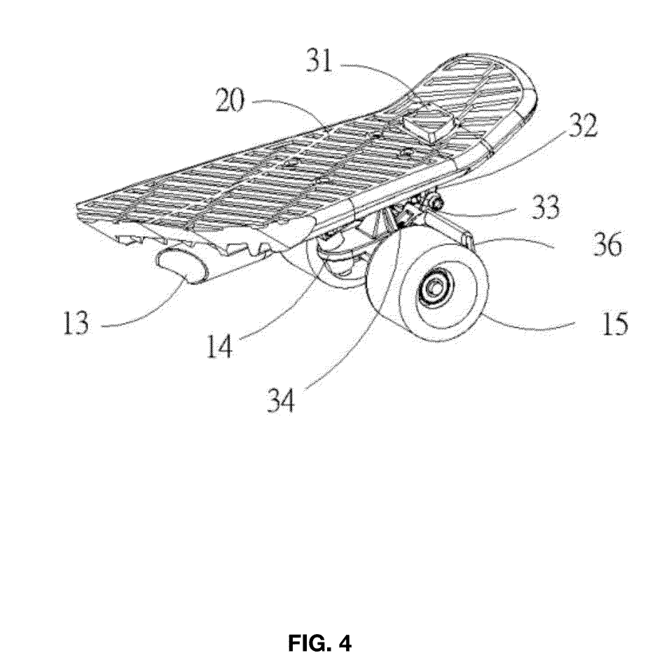

See FIG. 1, FIG. 2, FIG. 3, and FIG. 4, which, respectively, show a schematic diagram for the three-dimensional breakdown, a schematic diagram for a lateral view, a schematic diagram for a lateral view, and a schematic diagram for a partial magnified sectional view of the present utility model. The figures show a shifting lock of a scooter; the scooter is provided with a rod body 10. The top of the rod body 10 is provided with a grip part 11, and the bottom of the rod body 10 is pivoted to a front wheel 12. The rod body 10 extends backwards and is provided with a support bar 13. The upper part of the support bar 13 is provided with a plate body 20, and the latter end of the support bar 13 is pivoted to at least one rear wheel 15 by using a fixing seat 14, wherein: the rear wheel 15 is provided with a brake module 30. The brake module 30 comprises a driving component 31, a first connecting rod 32, a second connecting rod 33, and an elastic part 34. The lower part of the driving component 321 extends and is provided with the first connecting rod 32. The first connecting rod 32 is pivoted to one end of the second connecting rod 33 relative to the other end of the driving component 31. The second connecting rod 33 is pivoted to the fixing seat 14 relative to the other end of the first connecting rod 32, and the elastic part 34 is sleeved in the pivot shaft 35, the second connecting rod 33 extends towards the rear wheel 15 and is provided with a push surface 36.

In actual use, the driving component 31 is operated to drive the first connecting rod 32 and drag the push surface 36 of the second connecting rod 33 to press against the rear wheel 15. In addition, as the push surface 36 can only shift in the direction of the second connecting rod 33, the push surface 36 is driven to press against and slow down the rear wheel 15, thereby completing the action of braking, and the elastic part 34 can allow the second connecting rod 33, the first connecting rod 32, and the driving component 31 to restore to their respective original states in sequence.

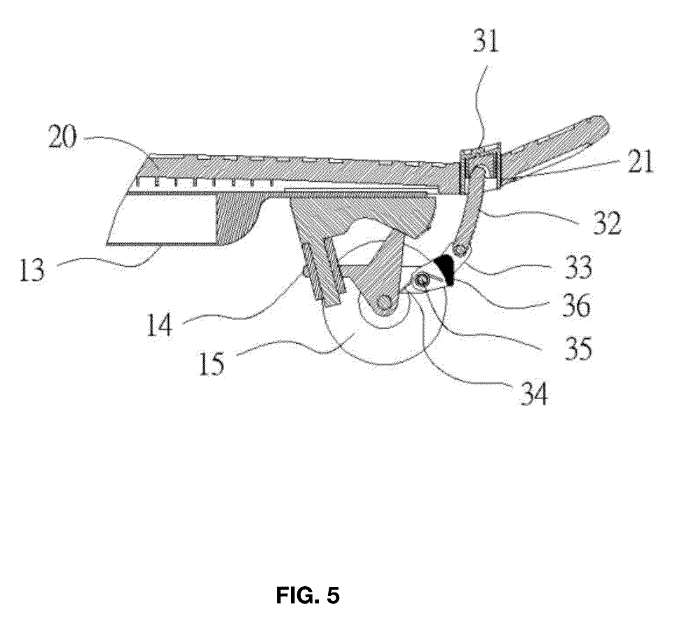

See FIG. 1 and FIG. 5, wherein, the support bar 13 is bonded with the plate body 20 by using at least one fixing module 40. In addition, the fixing module 40 comprises a fixing plate 41 and a plurality of screw-locking components 42. The fixing seat 14 is bonded with one side of the support bar 13 by using a fixing module 40. In addition, the elastic part 34 can be a torsion spring, a leaf spring, or a restoring spring. In addition, the brake module 30 is located relative to the rear of the rear wheel 15, or the brake module 30 is located relative to the front of the rear wheel 12.

Further, the push surface 36 is a brake block. The brake block can be made of any one of rubber, non-asbestos lining, semi-metallic lining, metallic lining, and composite lining or any combination thereof. In addition, the fixing seat 14 is pivoted to one rear wheel 15. As the push surface 36 can only shift in the direction of the second connecting rod 33, the push surface 36 is driven towards and slows down the rear wheel 15. In addition, the fixing seat 14 is pivoted to two rear wheels 15. The push surface 36 is formed by extending the second connecting rod 33 towards one of the rear wheels 15 so that the push surface 36 comes into contact with only one of the rear wheels 15. As the push surface 36 can only shift in the direction of the second connecting rod 33, the push surface 36 is driven towards and slows down the rear wheel 15. Further, the fixing seat 14 is pivoted to two rear wheels 15. The push surface 36 is formed by extending the second connecting rod 33 towards both rear wheels 15 so that the push surface 36 comes into contact with both rear wheels 15 and, as the push surface 36 can only shift in the direction of the second connecting rod 33, the push surface 36 is driven towards and slows down the rear wheels 15.

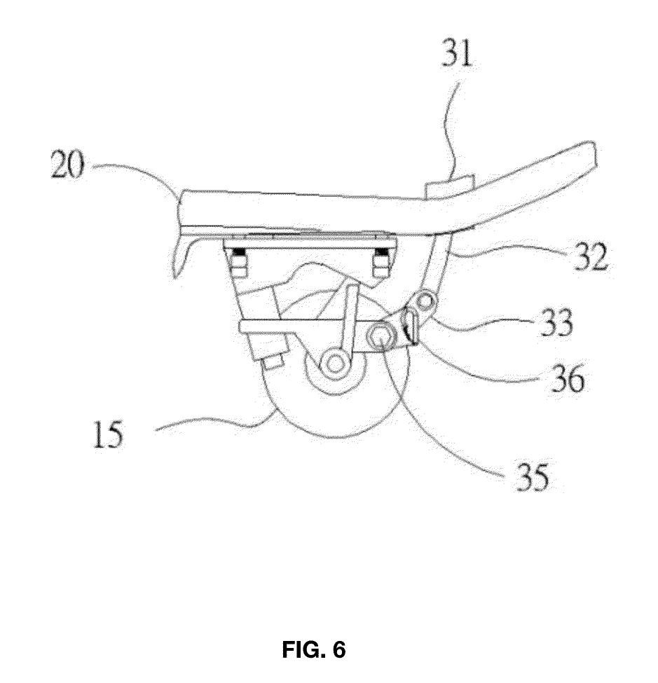

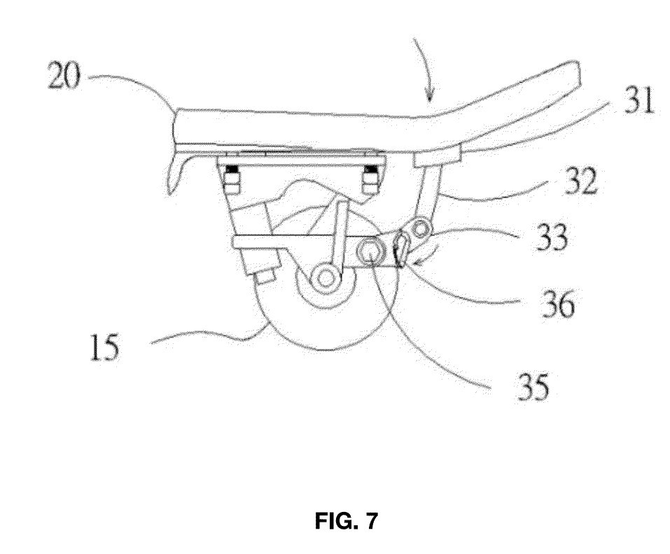

See FIG. 5, FIG. 6, and FIG. 7. Note that, the driving component 31 is a pedal part, and the surface of the pedal part is provided with a plurality of raised lines. The raised lines on the pedal part are made of rubber, which prevents slips when a foot stamps on the pedal part. In addition, the pedal part is embedded in a floating manner in the rear end of the plate board 20. In the embodiment shown in FIG. 5, the plate body 20 is provided with an opening 21 relative to the pedal part for exposing the pedal part outside the plate body 20, and a gap is provided between the pedal part and the opening 21. When operated, the pedal part, vertically shifting up and down in the floating mode, drives the first connecting rod 31 and drags the push surface 36 of the second connecting rod 33 to press against the rear wheel 15. As shown in Figure, the elastic part 34 provided at the pivot shaft 35 can allow the second connecting rod 33, the first connecting rod 32, and the pedal part to restore to their respective original states in sequence.

In the present embodiment, a resisting force is generated when the push surface directly comes into contact with and rubs the rear wheel 15. Meanwhile, the generated resisting force slows down the rear wheel 15. Thus, the rear wheel 15 exerts an opposite acting force against the ground to achieve the effect of braking, stopping the advancing scooter.

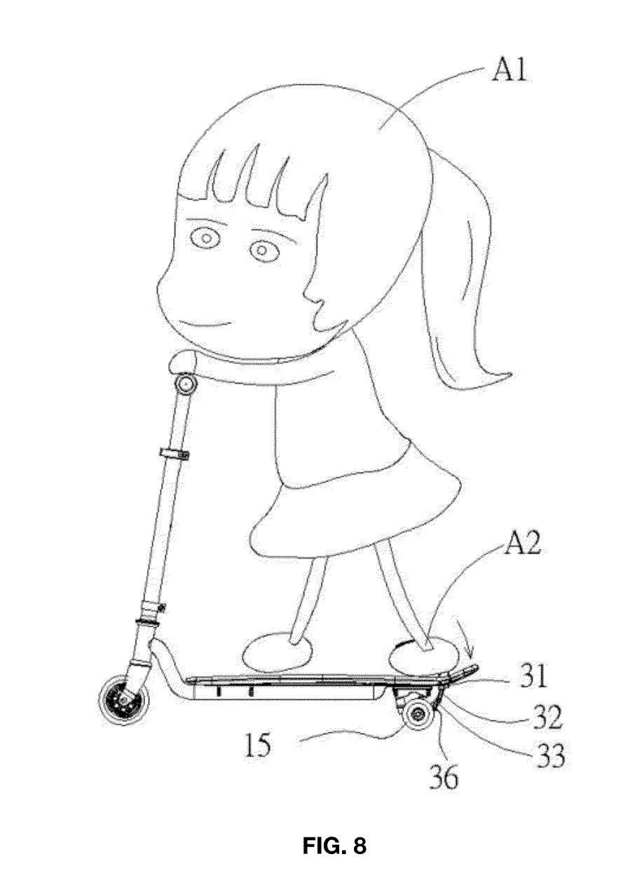

As shown in FIG. 8, in the actual implementation, the foot A2 of the user A1 exerts a force on the driving component 31. The driving component 31 drives the first connecting rod 32 and the second connecting rod 33 so that the push surface 36 comes into contact and rubs the rear wheel 15, thereby achieving the effect of slowing down and braking. When the user's foot loosens its pressure on the driving component 31, the resilience force of the elastic part allows the driving component 31, the first connecting rod 32, and the second connecting rod 33 to restore along with the push surface 36.

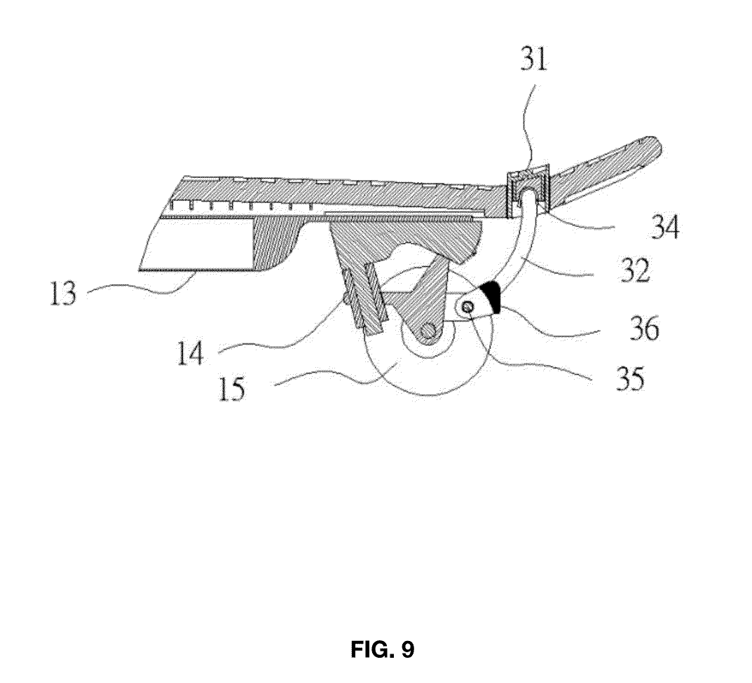

As shown in FIG. 9, the rear wheel 15 is provided with a brake module 30; the brake module 30 comprises a driving component 31 and at least one first connecting rod 32. The driving component 31 is connected to one end of the first connecting rod 32, and the other end of the first connecting rod 32 is pivoted to the fixing seat 14 by using a pivot shaft 35. The other end of the first connecting rod 32 extends towards the rear wheel 15 and is provided with a push surface 36. Certainly, as mentioned in the preceding embodiment, the elastic part 34 can be sleeved on the pivot shaft 35. Alternatively, the elastic part 34 can be sleeved outside the driving component 31, also achieving the effect of restoring the driving component.

Compared with the prior art, described herein is a shifting lock of a scooter, wherein: the driving component 31 is operated to drive the first connecting rod 32 and drag the push surface 36 of the second connecting rod 33 to press against the rear wheel 15. In addition, as the push surface 36 can only shift in the direction of the second connecting rod 33, the push surface 36 is driven to slow down the rear wheel 15, thereby completing the action of braking, and the elastic part 34 can allow the second connecting rod 33, the first connecting rod 32, and the driving component 31 to restore to their respective original states in sequence.

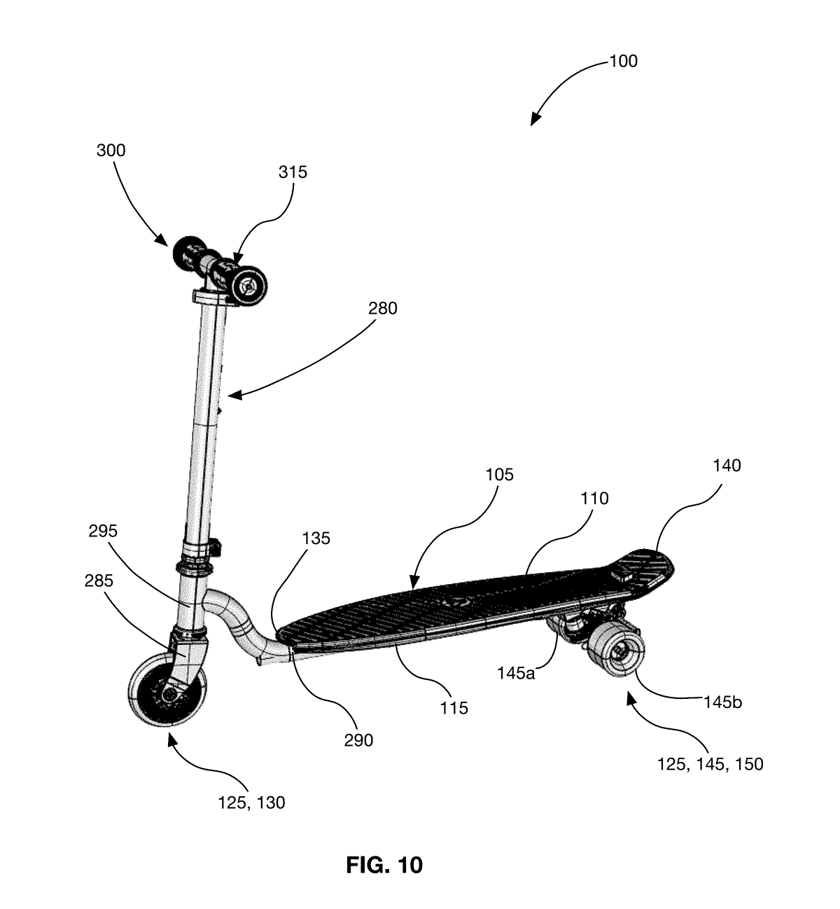

FIGS. 10 to 20 depict an example foot-deck-based vehicle 100. In these figures the vehicle 100 is depicted as a scooter, however it is understood that the foot-deck-based vehicle 100 is not limited to a scooter and may be, for example, a skateboard. It will be understood that in at least some instances herein where the vehicle 100 is referred to as a scooter, any other suitable vehicle 100 could alternatively be used. The foot-deck-based vehicle 100 includes a foot-deck 105 having, in use, a foot support surface 110 and an underside 115. The foot support surface 110 is positioned to support the feet of a user (not shown) while the foot-deck-based vehicle 100 is in use.

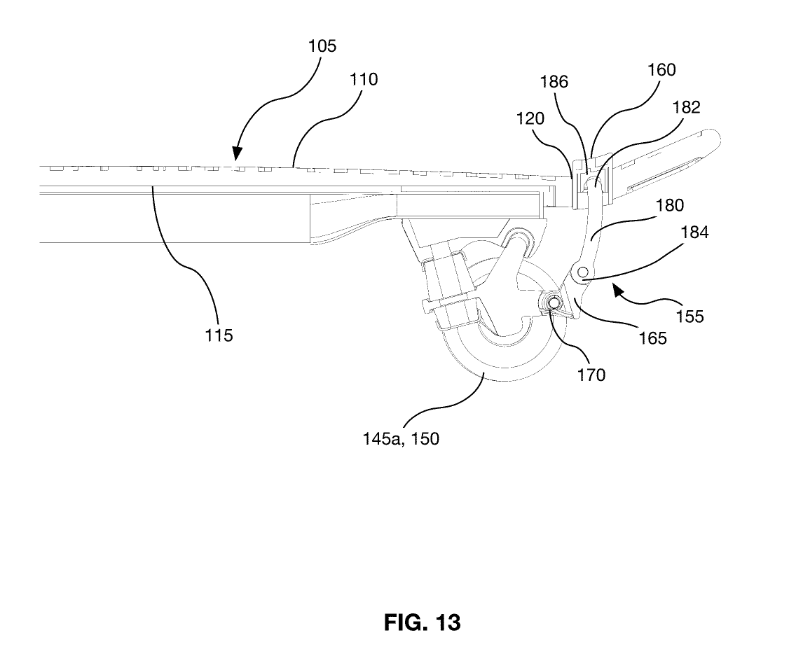

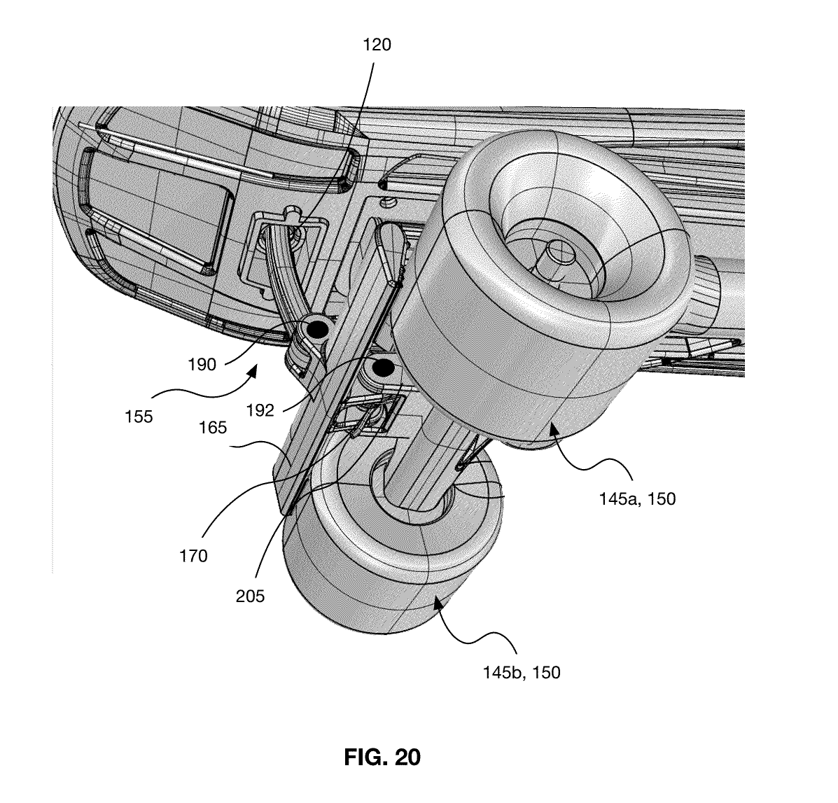

The foot-deck 105 has an aperture 120 (FIGS. 13, 20) that is through the depth of the foot-deck 105 between foot support surface 110 and the underside 115. Various aspects of the aperture 120 are discussed in more detail further below.

The foot-deck-based vehicle 100 also includes a plurality of wheels 125 that are positioned in association with the foot-deck 105 (e.g., the plurality of wheels 125 are positioned to support and to operate with the foot-deck 105). The plurality of wheels 125 includes at least one front wheel 130 that is proximate a front end 135 of the foot-deck 105 and at least one rear wheel positioned proximate a rear end 140 of the foot-deck 105, which is also referred to herein as at least one rear wheel 145. In the example foot-deck-based vehicle 100, the at least one rear wheel is a pair of rear wheels, individually referred to as rear wheel 145a and rear wheel 145b. However, in some embodiments, the at least one rear wheel 145 includes only one wheel and in some other embodiments, the at least one rear wheel 145 includes more than two wheels. The plurality of wheels 125 can be any suitable type of wheel or combination of suitable wheels. For example, the at least one rear wheel 145 can be a typical skateboard wheel.

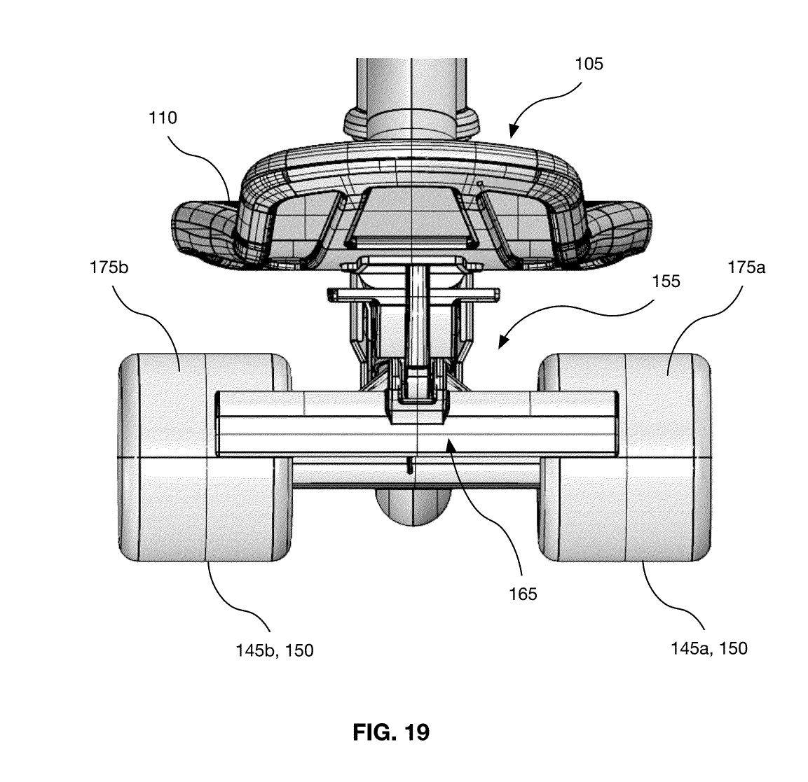

At least one of the plurality of wheels 125 is a brakable wheel 150. In other words, there is provided at least one brakable wheel 150. In some instances the term ‘brakable wheels’ may be used, however, it will be understood that in at least some of these instances, this terminology is used for readability and that the described embodiment could incorporate at least one breakable wheel 150 and not necessarily a plurality of breakable wheels 150. For example, in the example foot-deck-based vehicle 100, the rear wheel 145a and the rear wheel 145b are brakable wheels 150. However, in some embodiments, only one of the rear wheel 145a and the rear wheel 145b is a brakable wheel. Furthermore, in some embodiments, the at least one brakable wheel is one or more of the at least one front wheel 130. As depicted in FIG. 19, the brakable wheels 150 are positioned entirely beneath the foot-deck 105. However, in some embodiments, the brakable wheels 150 are not necessarily positioned entirely beneath the foot-deck 105. For example, in some embodiments the brakable wheels 150 are positioned such that at least a portion of one or more of the brakable wheels 150 is above the foot support surface 110 of the foot-deck 105.

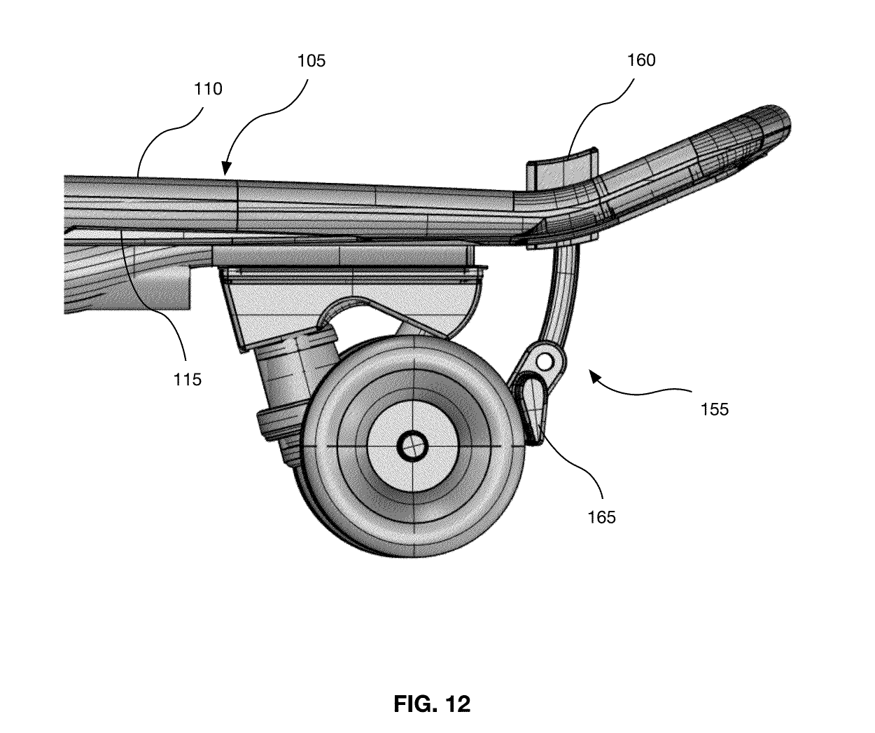

As better shown in FIGS. 12 to 20, the foot-deck-based vehicle 100 includes a brake mechanism 155 that can be actuated by a user's foot (not shown). The brake mechanism includes a foot-actuatable member 160, a braking member 165 and a biasing member 170. The foot-actuatable member 160 extends through the aperture 120 and, in use, up from the foot support surface 110. In other words, at least a portion of the foot-actuatable member 160 is above the foot-support surface 110 while the foot-actuatable member 160 is not being depressed (see FIG. 13). The foot-actuatable member 160 can be located proximate to a position where a user typically rests at least one of their feet.

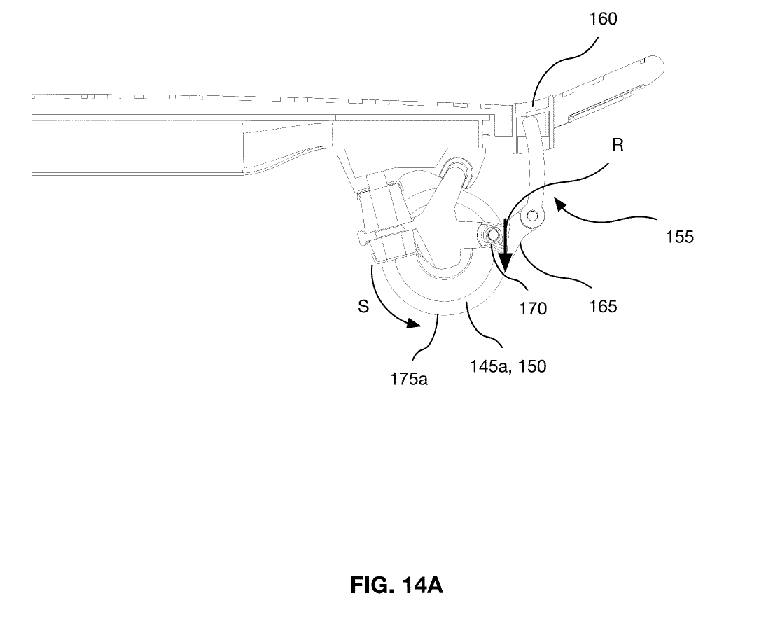

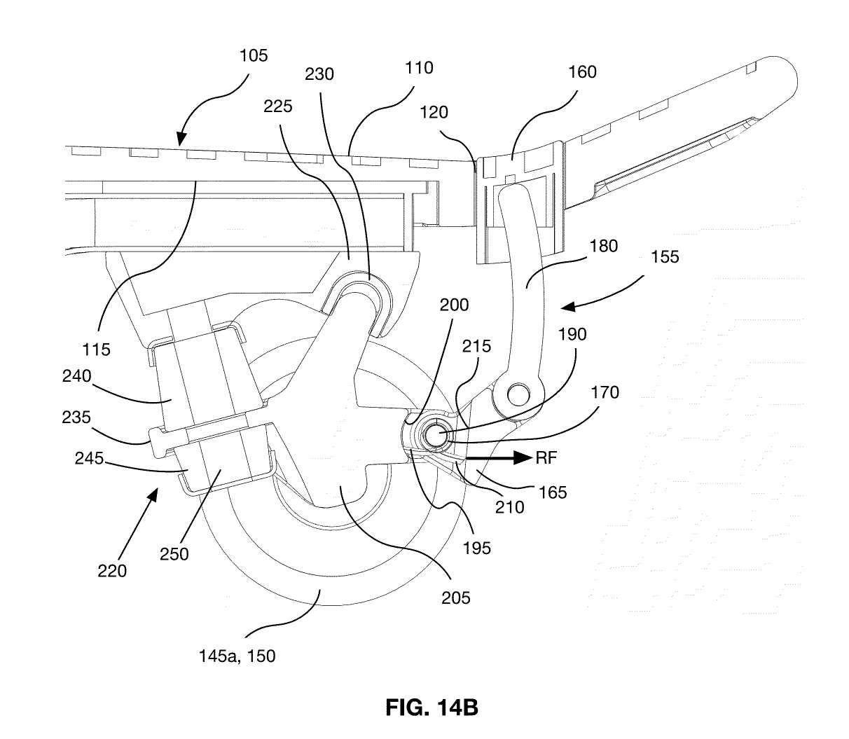

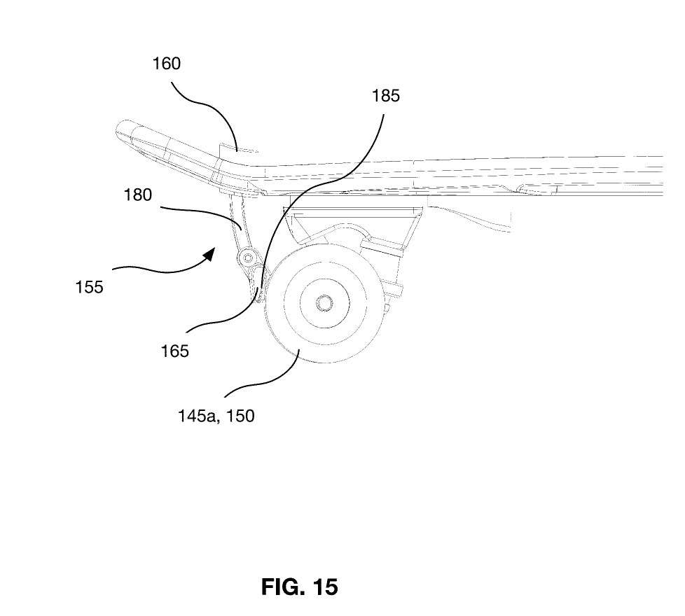

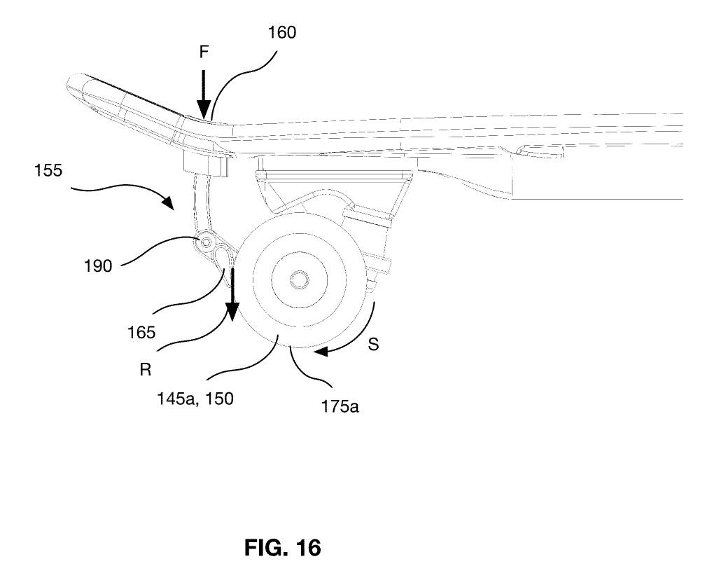

The braking member 165 is movable between a non-braking position away from the at least one brakable wheel 150, which in the example foot-deck-based vehicle 100 is the rear wheel 145a and rear wheel 145b (FIGS. 13, 15), and a braking position in which the braking member 165 engages the brakable wheels 150 to generate a resisting force R to reduce the speed of the foot-deck-based vehicle 100 (FIGS. 14A, 14B, 16). For example, as shown in FIGS. 14A and 16, when the braking member 165 is in the braking position, the braking member 165 contacts the rear wheel 145a and the rear wheel 145b (not shown). As the rear wheel 145a and the rear wheel 145b rotate in the direction S, the braking member 165 is dragged against the exterior surface 175a of the rear wheel 145a and the exterior surface 175b (FIG. 19) of the rear wheel 145b, thereby generating the resisting force R which counters the rotation of the rear wheel 145a and the rear wheel 145b in the direction S. The braking member 165 may be formed from any suitable material or combination of suitable materials, such as a suitable rubber or plastic. Furthermore, the braking member 165 may include certain features, such as the ridges 185 (FIG. 15), or at least one surface treated to increase the co-efficient of friction and thus increase the resisting force R generated in the braking position. In some embodiments, the braking member 165 may engage only one of the brakable wheels 150 (e.g., one of rear wheel 145a and rear wheel 145b) to reduce the speed of the foot-deck-based vehicle 100.

The foot-actuatable member 160 is operatively connected to the braking member 165 and is depressible towards the foot support surface 110 to move the braking member 165 to the braking position. For example, as shown in FIG. 13, the foot-actuatable member 160 can be connected to the braking member 165 via at least one connecting link 180 at a first end 182. The first end 182 may be pivotally connected to the foot-actuatable member 160 by, for example, a ball joint 186 to allow at least some relative movement between the foot-actuatable member 160 and the first end 182 of the at least one connecting link 180. At a second end 184, the at least one connecting link 180 is pivotally connected to the braking member 165 via a first pivot shaft 190 (FIG. 16). The braking member 165 can be pivotally connected to a rear wheel support 205 via a second pivot shaft 192 (FIG. 20). As a depressing load F (FIG. 16) is applied to the foot-actuatable member 160, the foot-actuatable member 160 moves towards the foot support surface 110 and the at least one connecting link 180 moves downwards, moving the second end 184 away from the underside 115 of the foot-deck 105. As the at least one connecting link 180 moves downwards, the braking member 165 is pivoted about the first pivot shaft 190 and moves towards the rear wheels 145 (e.g., rear wheel 145a, rear wheel 145b) to reach the braking position.

To help the braking member 165 return to the non-braking position, the brake mechanism 155 includes the biasing member 170. The biasing member 170 is positioned to urge the braking member 165 towards the non-braking position. For example, as shown in FIGS. 14A and 14B, the biasing member 165 can be a torsion spring that is sleeved on the first pivot shaft 190. As a torsion spring, the biasing member 165 includes a first spring end 195 that abuts a support surface 200 of the rear wheel support 205 and a second spring end 210 that abuts against a braking surface 215 on the braking member 165 when the braking member 165 is in the braking position (FIG. 14B). The first spring end 195 and the second spring end 210 are biased against unwinding the torsion spring. When the first spring end 195 abuts the support surface 200 and the second spring end 210 abuts the braking surface 215 together, the biasing member 165 as a torsion spring applies a returning force RF against the braking surface 215 to urge the braking member 165 out of the braking position and towards the non-braking position. Although the biasing member 170 is depicted as a torsion spring in the example foot-deck-based vehicle 100, the biasing member 170 can be any component or combination of components suitable for urging the braking member 165 towards the non-braking position. For example, the biasing member 170 can be a leaf spring. As another example, the biasing member 170 can include more than one torsion spring, leaf spring or combination of the two.

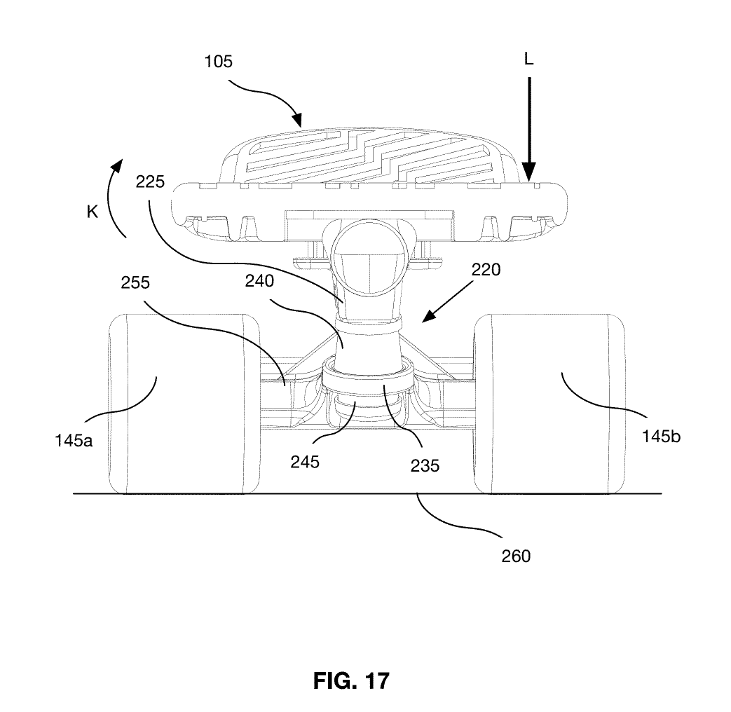

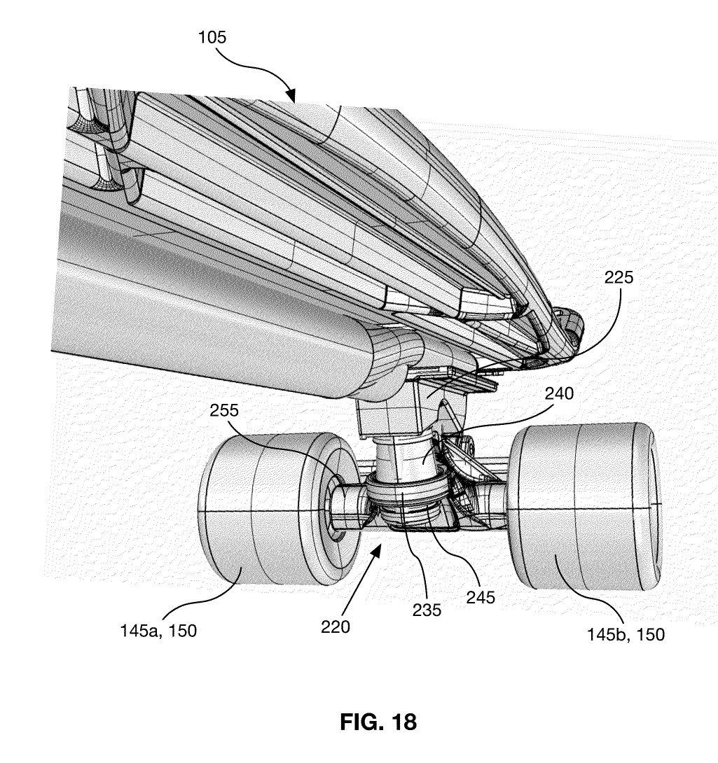

In some embodiments, the at least one rear wheel 145 is pivotally connected to the foot-deck 105 so as to permit leaning of the foot-deck 105 laterally relative to the at least one rear wheel 145 when steering the foot-deck-based vehicle 100. For example, as shown in FIGS. 14B, 17 and 18, the foot-deck-based vehicle 100 includes a truck 220 that is pivotally connected to the underside 115 of the foot-deck 105. The truck 220 includes the rear wheel support 205 that is pivotally connected to a support bracket 225 (that, in turn, is coupled to the underside 115) via a ball joint 230, and a disk-shaped lug 235 sandwiched between an upper resilient bushing 240 and a lower resilient bushing 245. A rod 250, such as a kingpin, extends through the assembly of the upper resilient bushing 240, the disk-shaped lug 235 and the lower resilient bushing 245 to connect to the support bracket 225. The at least one rear wheel 145 is rotatably coupled to the rear wheel support 205 via an axle 255 (FIGS. 17, 18).

As a leaning load L (FIG. 17) is applied to one lateral side of the foot-deck 105, the upper resilient bushing 240 and the lower resilient bushing 245 are compressed on a corresponding lateral side and the foot-deck 105 is permitted to rotate in the direction K. As a result, the rear wheel 145b is pressed into the surface 260 more than the rear wheel 145a, which allows a user (not shown) to steer the foot-deck-based vehicle 100.

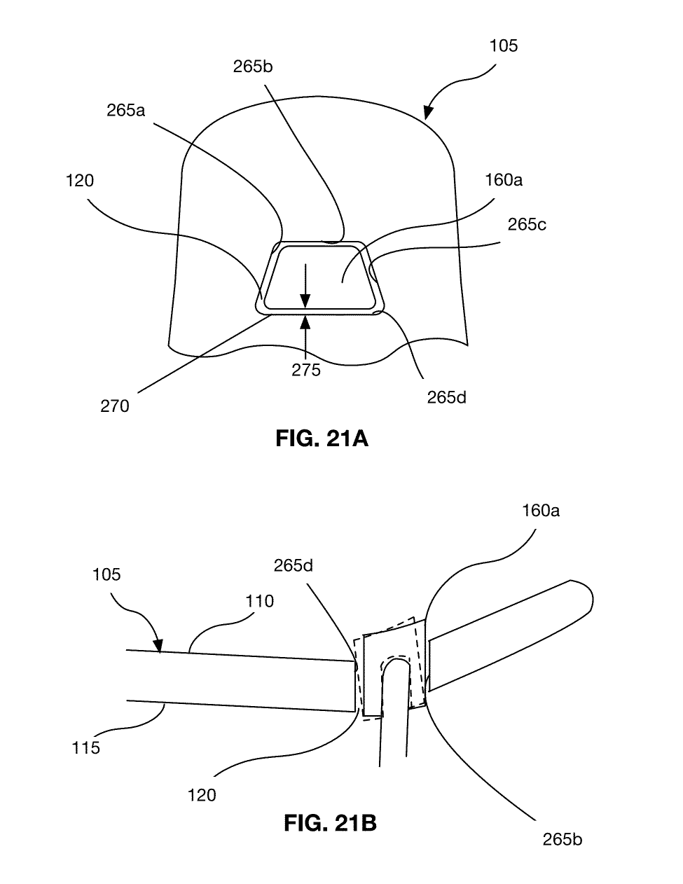

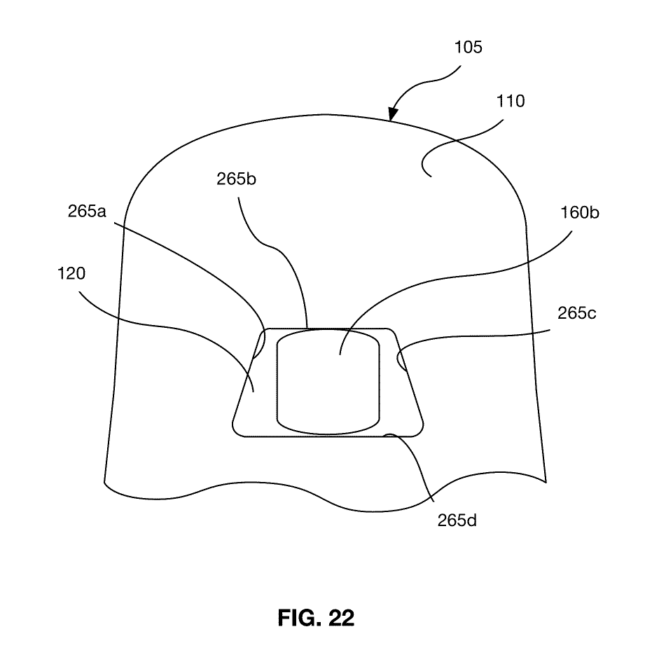

The aperture 120 and the foot-actuatable member 160 may be configured in a variety of ways. For example, the foot-actuatable member 160 may not be pivotally or fixedly connected to an interior surface of the aperture 120 or a surface of the foot-deck 105 (such as the foot support surface 110 and the underside 115). As an example, in FIGS. 21A and 21B, the foot-actuatable member, depicted as a foot-actuatable member 160a, does not contact any of the interior surfaces 265a, 265b, 265c or 265d of the aperture 120 when the braking member 165 is in the non-braking position. However, in some embodiments, as shown in FIG. 22, the foot-actuatable member, depicted as foot-actuatable member 160b, contacts at least one of the interior surfaces 265a, 265b, 265c and 265d, but is not pivotally or fixedly coupled to any of the interior surfaces 265a, 265b, 265c and 265d. By not pivotally or fixedly coupling the foot-actuatable member to any of the interior surfaces of the aperture in the foot-deck, at least some lateral movement of the foot-actuatable member can be accommodated within the aperture (e.g., towards any of the interior surfaces of the aperture in the foot-deck).

Returning to the example aperture and foot-actuatable member depicted in FIG. 21A, the foot-actuatable member 160a is separated from a peripheral edge 270 of the aperture 120 by a gap 275. The gap 275 permits an orientation of the foot-actuatable member 160a to change relative to the foot-deck 105 during steering of the foot-deck-based vehicle 100 (see FIG. 21B).

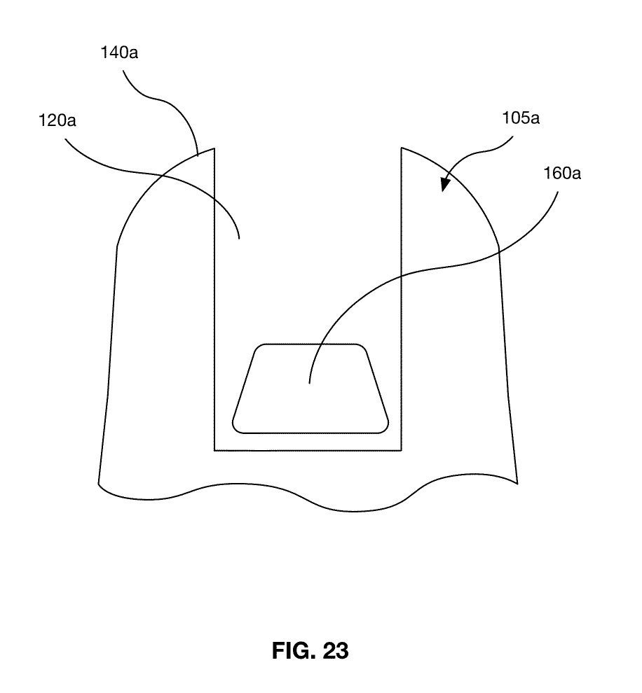

In the example aperture 120 shown in FIGS. 21A and 21B, the peripheral edge 270 is completely closed by the foot-deck 105. However, the aperture 120 can take a variety of forms. For example, as shown in FIG. 23, the aperture, shown as aperture 120a, can be an open-ended slot in the foot-deck 105 (shown as an open-ended slot opening towards the rear end 140a of the foot-deck 105a).

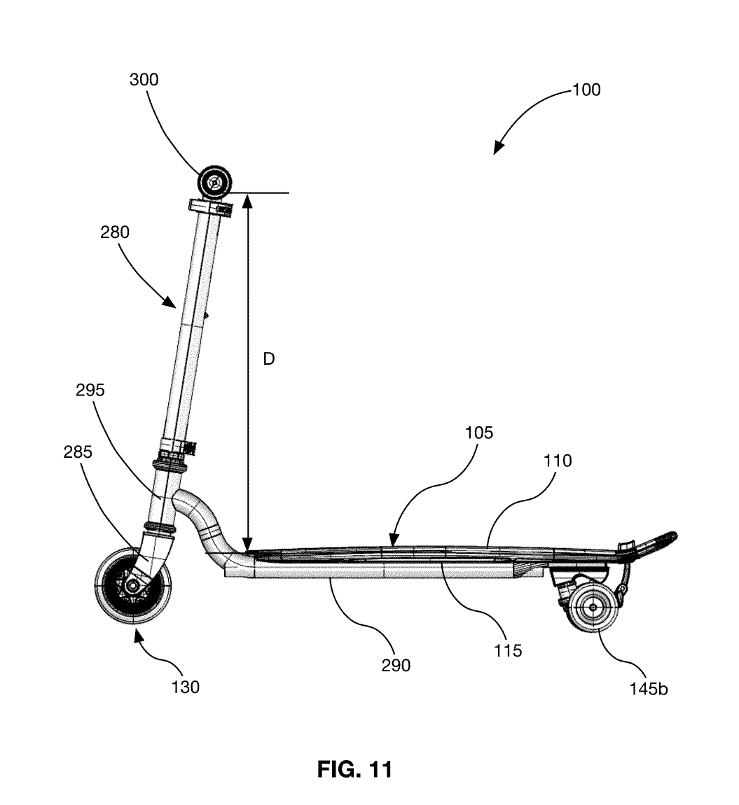

The foot-deck-based vehicle 100 can include a variety of features to enhance usability and safety. For example, the foot-deck-based vehicle 100 can include a steering column 280 (FIGS. 10, 11) that extends, in use, up from the foot-deck 105 and is turnable to pivot the at least one front wheel 130 relative to the foot-deck 105 when steering the foot-deck based vehicle 100. In the example foot-deck-based vehicle 100, the steering column 280 is connected to a fork 285 that is rotatably coupled to the at least one front wheel 130. The steering column 280 is pivotally coupled to a deck support 290 via a steering sleeve 295. The steering column 280 may be extendable and retractable in order to adjust a vertical distance D of a handlebar 300 coupled to the steering column 280 from the foot support surface 110 while the foot-deck-based vehicle 100 is in use. The handlebar 300 may include rubber hand grips 315 (FIG. 10) that may absorb at least some of the vibration transmitted through the handlebar 300 from the plurality of wheels 125.

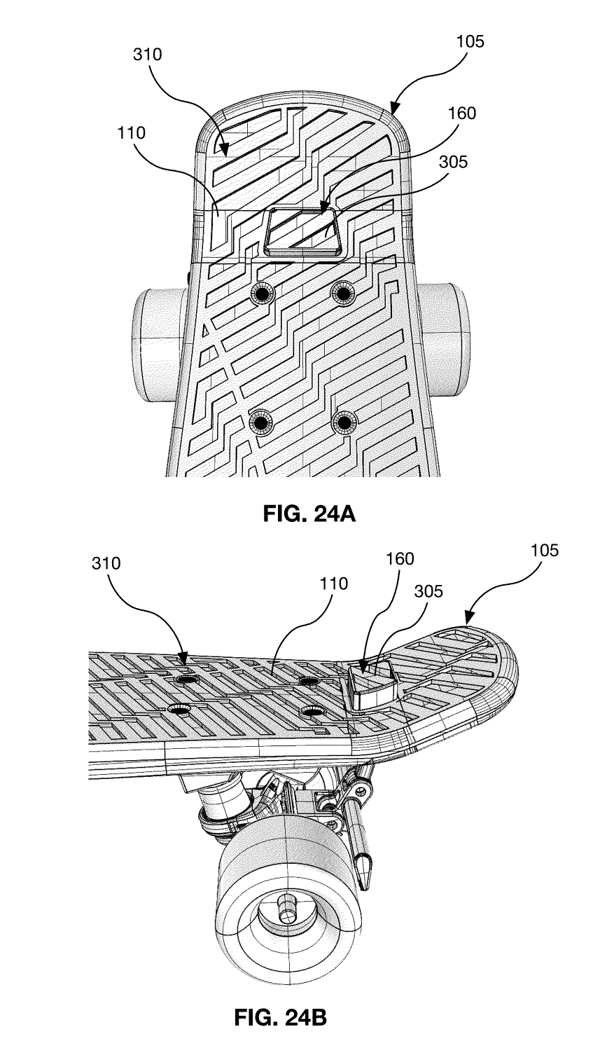

The foot-deck 105 may also include surfaces that are configured to inhibit slipping between a user's foot and the foot-deck 105 and/or the foot-actuatable member 160. For example, as shown in FIGS. 24A and 24B, the foot support surface 110 and an upper surface 305 of the foot-actuatable member 160 includes a plurality of raised grip members 310. The plurality of raised grip members 310 can be formed of a resilient material that deforms as pressure is applied to any of the plurality of raised grip members 310 by the user's foot. In some embodiments, the plurality of raised grip members 310 are applied separately to the foot support surface 110. In some embodiments, the plurality of raised grip members 310 are moulded components of the foot support surface 110. In some embodiments, one or more of the foot support surface 110 and the upper surface 305 include materials that are abrasive.

In some embodiments, the foot-actuatable member 160 may only rise approximately 1.5 inches or less from the foot support surface 110 (permissible by providing the brakable wheels entirely beneath the foot-deck 105) and is surrounded on at least three sides by the foot-deck 105, thereby providing stable footing for the user even while braking.

Persons skilled in the art will appreciate that there are yet more alternative implementations and modifications possible, and that the above examples are only illustrations of one or more implementations. The scope, therefore, is only to be limited by the claims appended hereto.

What is claimed is:

1. A brake module for a scooter having a plate body having an opening, at least one front wheel and at least one rear wheel, the brake module comprising:
a driving component that extends through the opening in the plate body;
at least one connecting rod coupled to the driving component at one end of the at least one connecting rod;
a push surface coupled to another end of the at least one connecting rod, the push surface configured to contact the at least one rear wheel, and to generate a resisting force against rotation of the at least one rear wheel when the push surface is moved to contact the at least one rear wheel; and
an elastic part positioned to apply a restoring force against the push surface when the push surface contacts the at least one rear wheel to move the push surface away from the at least one rear wheel;
wherein the driving component is configured to drive the at least one connecting rod towards the at least one rear wheel in response to a downward force applied to the driving component,
wherein the push surface is moved by the at least one connecting rod into contact with the at least one rear wheel.

2. The braking module of claim 1, wherein the at least one connecting rod comprises:
a first connecting rod including the one end coupled to the driving component and including a second end; and
a second connecting rod pivotally coupled to the first connecting rod at the second end and including the another end coupled to the push surface.

3. The braking module of claim 1, wherein the driving member extends through the opening in a floating manner.

4. The braking module of claim 1, wherein the driving component is a pedal part.

5. The braking module of claim 1, wherein:
the scooter further comprises a support bar coupled to the plate body; and
the braking module further comprises
a fixing seat pivotally coupled to the support bar and coupled to the at least one rear wheel, and
a pivot shaft coupled to the fixing seat;
wherein the another end of the at least one connecting rod is pivotally coupled to the shaft and the push surface is formed as an extension of the at least one connecting rod from the another end, and
wherein the elastic part is coupled to the shaft.

6. The braking module of claim 1, wherein the push surface is an extension of the at least one connecting rod.

7. A foot-deck-based vehicle, comprising:
a foot-deck having, in use, a foot support surface and an underside, wherein, in use, the foot support surface is positioned to support the feet of a user, wherein the foot-deck has an aperture therethrough between the foot support surface and the underside;
a plurality of wheels including at least one front wheel positioned proximate a front end of the foot-deck and at least one rear wheel positioned proximate a rear end of the foot-deck, wherein the plurality of wheels are positioned in association with the foot-deck, wherein at least one of the plurality of wheels is a brakable wheel which is positioned entirely beneath the foot-deck;
a foot-actuatable member that extends through the aperture and, in use, up from the foot support surface;
a braking member movable between a non-braking position away from the at least one brakable wheel and a braking position in which the braking member engages the at least one brakable wheel to generate a resisting force to reduce speed of the foot-deck-based vehicle, wherein the foot-actuatable member is operatively connected to the braking member and is depressible towards the foot support surface to move the braking member to the braking position; and
a biasing member positioned to urge the braking member towards the non-braking position.

8. A foot-deck-based vehicle as claimed in claim 7, wherein the at least one brakable wheel is at least one of the at least one rear wheel.

9. A foot-deck-based vehicle as claimed in claim 7, wherein the at least one front wheel is connected to a steering column that extends, in use, up from the foot-deck and that is turnable to pivot the at least one front wheel relative to the foot-deck when steering the foot-deck based vehicle.

10. A foot-deck-based vehicle as claimed in claim 7, wherein the at least one rear wheel is pivotally connected to the foot-deck so as to permit leaning of the foot-deck laterally relative to the at least one rear wheel when steering the foot-deck-based vehicle.

11. A foot-deck-based vehicle as claimed in claim 10, wherein the foot-actuatable member is not pivotally or fixedly connected to any interior surface of the aperture.

12. A foot-deck-based vehicle as claimed in claim 11, wherein the foot-actuatable member is separated from a peripheral edge of the aperture by a gap so as to permit an orientation of the foot-actuatable member to change relative to the foot-deck during steering of the foot-deck-based vehicle.

13. A foot-deck-based vehicle as claimed in claim 12, wherein the at least one rear wheel is rotatably connected to a rear wheel support, which is pivotally connected to the foot-deck, and wherein the braking member is pivotally connected to the rear wheel support, wherein the foot-deck-based vehicle further comprises at least one connecting link that has a first end that is pivotally connected to the foot-actuatable member and a second end that is pivotally connected to the braking member.

14. A brake mechanism for a foot-deck-based vehicle, wherein the foot-deck-based vehicle includes a foot-deck having, in use, a foot support surface and an underside, wherein, in use, the foot support surface is positioned to support the feet of a user, wherein the foot-deck has an aperture therethrough between the foot support surface and the underside, and wherein the foot-deck-based vehicle further includes a plurality of wheels including at least one front wheel positioned proximate a front end of the foot-deck and at least one rear wheel positioned proximate a rear end of the foot-deck, wherein the plurality of wheels are positioned in association with the foot-deck, wherein at least one of the plurality of wheels is a brakable wheel which is positioned entirely beneath the foot-deck, wherein the brake mechanism comprises:
a foot-actuatable member that extends through the aperture and, in use, up from the foot support surface;
a braking member movable between a non-braking position away from the at least one brakable wheel and a braking position in which the braking member engages the at least one brakable wheel to generate a resisting force to reduce speed of the foot-deck-based vehicle, wherein the foot-actuatable member is operatively connected to the braking member and is depressible towards the foot support surface to move the braking member to the braking position; and
a biasing member positioned to urge the braking member towards the non-braking position.

15. A brake mechanism for a foot-deck-based vehicle as claimed in claim 14, wherein the at least one brakable wheel is the at least one rear wheel.

16. A brake mechanism for a foot-deck-based vehicle as claimed in claim 14, wherein the at least one front wheel is connected to a steering column that extends, in use, up from the foot-deck and that is turnable to pivot the at least one front wheel relative to the foot-deck when steering the foot-deck based vehicle.

17. A brake mechanism for a foot-deck-based vehicle as claimed in claim 14, wherein the at least one rear wheel is pivotally connected to the foot-deck so as to permit leaning of the foot-deck laterally relative to the at least one rear wheel when steering the foot-deck-based vehicle.

18. A brake mechanism for a foot-deck-based vehicle as claimed in claim 17, wherein the foot-actuatable member is free of any pivotal or fixed connection to any interior surface of the aperture.

19. A brake mechanism for a foot-deck-based vehicle as claimed in claim 18, wherein the foot-actuatable member is separated from a peripheral edge of the aperture by a gap so as to permit an orientation of the foot-actuatable member to change relative to the foot-deck during steering of the foot-deck-based vehicle.

20. A brake mechanism for a foot-deck-based vehicle as claimed in claim 19, wherein the at least one rear wheel is rotatably connected to a rear wheel support, which is pivotally connected to the foot-deck, and wherein the braking member is pivotally connected to the rear wheel support, wherein the foot-deck-based vehicle further comprises at least one connecting link that has a first end that is pivotally connected to the foot-actuatable member and a second end that is pivotally connected to the braking member.
